(19) United States
(12) Patent Application Publication
(10) Pub. No.: US 2024/0339766 A1
(43) Pub. Date: Oct. 10, 2024

(54) CONNECTING ARRANGEMENT WITH A CRIMP CONNECTION AND METHOD FOR PRODUCING A CONNECTING ARRANGEMENT WITH A CRIMP CONNECTION

(71) Applicant: PHOENIX CONTACT E-Mobility GmbH, Schieder-Schwalenberg (DE)

(72) Inventor: Carsten Kuckuck, Hameln (DE)

(21) Appl. No.: 18/578,017

(22) PCT Filed: Jul. 7, 2023
(86) PCT No.: PCT/EP2022/068823

§ 371 Date: Jan. 10, 2024

(30) Foreign Application Priority Data
Jul. 12, 2021 (LU) LU500419

(51) Int. Cl. H01R 4/20; H01R 43/048

(52) U.S. Cl. CPC H01R 4/20; H01R 43/048

(57) ABSTRACT

A connecting arrangement includes: a support sleeve; and a contact sleeve for receiving an electrical conductor which has individual wires as a received electrical conductor. The contact sleeve is received at least in sections in the support sleeve. The contact sleeve includes an active section for forming a crimp connection at least in sections with the received electrical conductor. The support sleeve at least maintains a contact surface pressure, at least in sections, between the active section and the received electrical conductor and/or, at least in sections, between the individual wires of the received electrical conductor.

### CROSS-REFERENCE TO PRIOR APPLICATIONS

This application is a U.S. National Phase application under 35 U.S.C. § 371 of International Application No. PCT/EP2022/068823, filed on Jul. 7, 2022, and claims benefit to Luxembourg Patent Application No. LU 500419, filed on Jul. 12, 2021. The International Application was published in German on Jan. 19, 2023 as WO/2023/285252 under PCT Article 21 (2).

### FIELD

The present invention relates to a connecting arrangement with a crimp connection and a method for producing a connecting arrangement with a crimp connection.

### BACKGROUND

There are basically two main factors to consider when using crimp connections with electrical conductors. These are on the one hand the so-called wire cross-contact and on the other hand the so-called conductor contact.

Wire cross-contacting refers to the electromechanical contacting of individual wires with each other. A sufficient wire cross-contacting is necessary in particular so that the current-carrying capacity of each individual wire can be utilized. In addition, sufficient wire cross-contacting and thus the entire conductor cross-section can contribute homogeneously to the transmission of electrical energy. The quality of the wire cross-contact is determined by the quality of all the individual electromechanical contacts together. The individual contact regions are in turn dependent on the shaping of the wire and the wire surface condition. As the number of wires in the conductor increases, for example the influence of the wire cross-contacting on the overall quality of the crimp connection also increases. Electrical energy here must be transferred from the inner wires or wire layers to the outer wires or wire layers.

In contrast to wire cross-contacting, conductor contacting describes the mutual electromechanical contacting of individual wires with the crimp contact element of the crimp connection. Here, the entire electrical energy of the electrical conductors is transmitted into the crimp contact element. In other words, the conductor contacting forms the transition between the electrical conductor and the crimp contact element.

Due to the interdependence of the individual contacts to each other, wire cross-contacting and conductor contacting together significantly determine the electromechanical contact behavior of a crimp connection. The multiplicity of individual contacts therefore influences the electrical contact quality and stability of the entire conductor contact system of the crimp connection, wherein furthermore, the number of conductor contact regions also plays an important role due to the conductor cross-section and the conductor class.

German patent No. DE 10 2015 004 485 B4 discloses a method for producing a plug connector arrangement which comprises a plug connector and a coaxial cable connected thereto. First, a support sleeve is pushed onto one end of the coaxial cable, then an outer conductor of the coaxial cable is folded back around the support sleeve, and finally one end of the coaxial cable with the support sleeve is inserted into a sleeve section of an outer conductor housing of the plug connector.

Furthermore, a plug connector arrangement having a compensation sleeve is known from utility model No. DE 20 2015 000 750 U1. The arrangement relates to a plug connector and a cable connected thereto with an inner conductor and an outer conductor surrounding the inner conductor. The outer conductor of the cable is electrically connected to an outer conductor housing of the plug connector. The inner conductor is surrounded by a circumferential sleeve part which has approximately the same inner diameter as the outer conductor of the cable.

### SUMMARY

In an embodiment, the present invention provides a connecting arrangement, comprising: a support sleeve; and a contact sleeve configured to receive an electrical conductor which has individual wires as a received electrical conductor, wherein the contact sleeve is received at least in sections in the support sleeve, wherein the contact sleeve comprises an active section configured to form a crimp connection at least in sections with the received electrical conductor, and wherein the support sleeve is configured at least to maintain a contact surface pressure, at least in sections, between the active section and the received electrical conductor and/or, at least in sections, between the individual wires of the received electrical conductor.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a side view of an embodiment of a connecting arrangement according to the present invention before a crimp connection is formed;

FIG. 2 shows a sectional view (section A-A in FIG. 1) of the exemplary embodiment of the connecting arrangement shown in FIG. 1:

FIG. 3 shows another side view of the embodiment of the connecting arrangement according to the present invention:

FIG. 4 shows a sectional view (section B-B in FIG. 3) of the embodiment of the connecting arrangement shown in FIG. 3 before a crimp connection is formed:

FIG. 5 shows a sectional view of a part of the embodiment of the connecting arrangement when a crimp connection is formed.

### DETAILED DESCRIPTION

In an embodiment, the present invention provides a connecting arrangement with a crimp connection which is characterized by improved permanent electromechanical contacting and by simple production.

According to a first general aspect, the present invention relates to a connecting arrangement comprising a supporting sleeve and a contact sleeve for receiving an electrical conductor which has individual wires, and thus an electrical conductor having individual wires, wherein the contact sleeve, at least in sections, is received in the supporting sleeve, preferably in a longitudinal direction, wherein the contact sleeve comprises an active section in order to form, at least in sections, a crimp connection with the electrical conductor received in the contact sleeve, wherein the supporting sleeve is configured and/or designed, when the crimp connection is formed, at least to maintain contact surface pressure, preferably a radial contact surface pressure or a contact surface pressure perpendicular to the longitudinal direction, at least in sections, between the active section and the received electrical conductor and/or, at least in sections, between the individual wires of the received electrical conductor.

The present invention can, for example, provide a connection arrangement which ensures a corresponding contact quality of the crimp connection. In other words, the stability of the electromechanical contacting of the crimp connection can be improved by the present invention.

Furthermore, for example surfaces of components and elements that need to be correspondingly coated for the crimp connection or in the region of the crimp connection can be reduced. In addition, the connection arrangement is preferably also characterized by simple manufacture, which is associated for example with a reduction in the production time of the connection arrangement.

The individual wires of the electrical conductor are preferably cores for transmitting electrical energy and/or electrical signals. The longitudinal direction can preferably be a conductor insertion direction of or for the electrical conductor.

According to a further aspect of the invention, it can be provided that the active section and/or a support section of the support sleeve which is assigned to the active section is designed to be plastically deformable or plastically deformed at least in sections.

The active section and the support section can make positive-fit and/or non-positive-fit contact with each other at least in sections on corresponding surfaces. It is possible for the support sleeve and preferably the support section to induce a substantially constant contact surface pressure in the contact sleeve and preferably the active section of the contact sleeve, preferably around the circumference of the contact sleeve and in the longitudinal direction, in which the contact sleeve preferably extends.

According to a further aspect of the invention, it can be provided that the support sleeve is formed from a support sleeve material and the contact sleeve is formed from a contact sleeve material, wherein the modulus of elasticity of the support sleeve material is greater than the modulus of elasticity of the contact sleeve material at least within the range of an ideal elastic-plastic material behavior, wherein the contact sleeve material is preferably electrically conductive.

The electrical conductor, preferably the individual wires of the electrical conductor, is/are made, electrically conductively, of a conductor material.

In other words, the support sleeve can be made of a stiffer material than the contact sleeve.

It is also possible for the support sleeve to be made of a support sleeve material and the contact sleeve to be made of a contact sleeve material, wherein the yield strength of the support sleeve material is lower than the yield strength of the contact sleeve material, at least within the range of an ideal elastic-plastic material behavior.

In other words, the contact sleeve and thus the material of the contact sleeve can withstand higher mechanical stresses, up to which it is at least elastically deformable, than the support sleeve.

It is possible for the electrical conductor, preferably the individual wires of the electrical conductor, to be made of a conductor material, wherein the yield strength of the support sleeve material is lower than the yield strength of the conductor material.

According to a further aspect of the invention, it can be provided that the support sleeve has a conductor insertion section, wherein the conductor insertion section is funnel-shaped at least in sections and, preferably in the longitudinal direction, merges into the support section.

As a result, the electrical conductor can, for example, be inserted with the individual wires relatively easily into the contact sleeve and the support sleeve.

It is possible for the contact sleeve to be rotationally symmetrical, preferably hollow-cylindrical, at least in sections, at least in the region of the active section.

This can ensure a corresponding plastic deformability when the crimp connection is formed, after which the contact surface pressures of the crimp connection are at least maintained.

It is possible for the support sleeve to have, at least in sections, at least one support section assigned to the region of the active section, wherein at least the support section is rotationally symmetrical, preferably hollow-cylindrical.

The support section can preferably at least cover the active section in the longitudinal direction. In other words, the support section can extend in the longitudinal direction at least along the active section.

According to a further aspect of the invention, it can be provided that the support sleeve has at least one stop element in order to bear or support at least the contact sleeve in the longitudinal direction.

Additionally or alternatively, it is also possible for the at least one stop element to support an insulation of the electrical conductor in the longitudinal direction. This can ensure, for example, that the electrical conductor is arranged with a defined length at least in the contact section. The at least one stop element can for example be annular.

According to a further aspect of the invention, it can be provided that the support sleeve has at least one recess extending at least in sections around the circumference of the support sleeve, preferably when the crimp connection is formed. The recess can, for example, be slot-shaped.

This can, for example, ensure a higher degree of plastic deformation of the support sleeve, preferably of the support section, preferably at edge regions of the crimp connection in the longitudinal direction. It is also possible for the edge regions of the support sleeve to be decoupled in some regions from the mechanical load caused by the crimping process, which can reduce the geometric change in shape of the edge regions.

It is possible for the support sleeve to extend substantially in the longitudinal direction at least over the active section, preferably when the crimp connection is formed. As a result, for example an almost complete coverage of the crimp connection by the support sleeve can be ensured, which leads for example to an optimal and/or homogeneous distribution of the contact surface pressure.

According to a further aspect of the invention, it can be provided that the support sleeve and the contact sleeve form, at least in sections, a positive and/or non-positive connection, preferably when the crimp connection is formed.

Preferably, the contact sleeve can be formed from a copper alloy, preferably based on pure copper, or from a brass alloy, preferably based on CuZn30 to CuZn42, and/or the electrical conductor can be made of copper.

According to a second general aspect, the present invention relates to a method for producing a connecting arrangement, preferably a connecting arrangement as disclosed herein, comprising a support sleeve and a contact sleeve for receiving an electrical conductor which has individual wires, wherein the contact sleeve is received in the support sleeve at least in sections, preferably in a longitudinal direction, wherein the received contact sleeve in the support sleeve comprises an active section, and the electrical conductor is received in the received contact sleeve, preferably in the active section, and a crimp connection is formed at least in sections by means of a crimping tool which is applied to the support sleeve in the region of the active section, wherein the support sleeve is configured to at least partially maintain a contact surface pressure at least in sections between the active section and the received electrical conductor, and/or at least in sections between the individual wires of the received electrical conductor.

Identical or functionally equivalent components or elements are denoted by the same reference signs in the figures. For the explanation thereof, reference is also made in part to the description of other exemplary embodiments and/or Figures in order to avoid repetitions.

The following detailed description of the exemplary embodiments illustrated in the figures serves for more detailed illustration or clarification and is not intended to limit the scope of the present invention in any way.

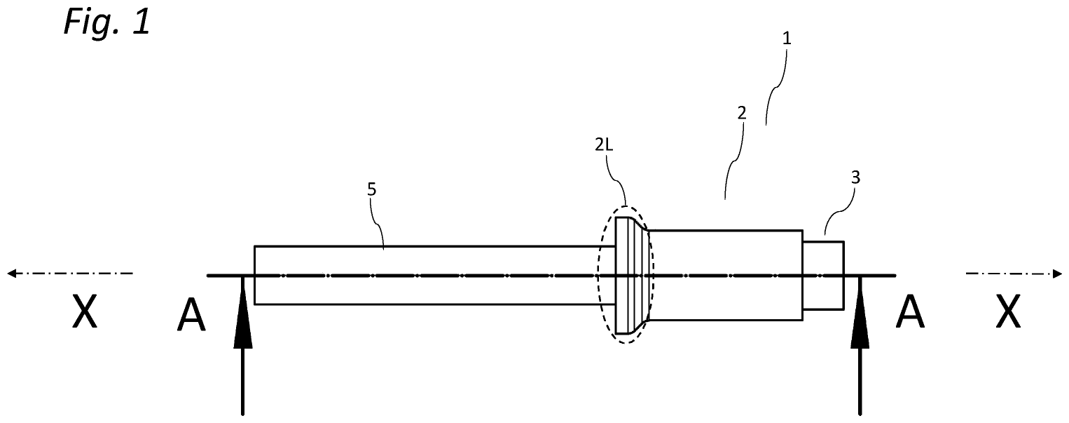

FIG. 1 shows a side view of an embodiment of a connecting arrangement 1 according to the present invention before a crimp connection is formed.

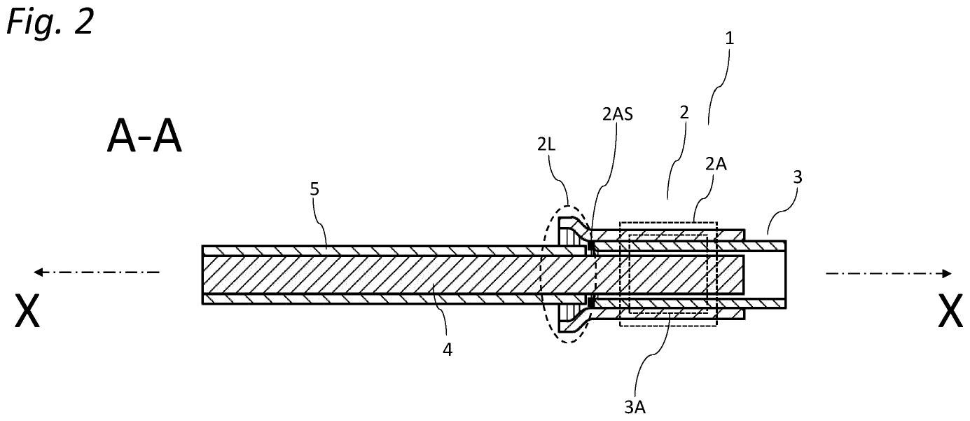

The connecting arrangement 1 comprises an electrical conductor 4 (see also FIGS. 2, 4 and 5), of which the insulation 5 is shown in FIG. 1. The connecting arrangement 1 includes a support sleeve 2 and a contact sleeve 3. The support sleeve 2 extends substantially in the longitudinal direction X. The longitudinal direction X can preferably be an insertion direction of the electrical conductor 4 into the contact sleeve 3. The support sleeve 2 is substantially rotationally symmetrical and, at least in sections, hollow-cylindrical in shape. The hollow-cylinder-shaped design of the support sleeve 2 extends substantially in the longitudinal direction X. The support sleeve 2 also has a conductor insertion section 2L. The conductor insertion section 2L of the support sleeve 2 is substantially funnel-shaped and is used for the insertion of the electrical conductor 4 into the inner region of the support sleeve 2, and preferably of the contact sleeve 3 received in the support sleeve 2. The contact sleeve 3 is substantially rotationally symmetrical and is hollow-cylindrical along the insertion direction X.

The connecting arrangement 1 according to the embodiment shown in FIG. 1 before forming a crimp connection is characterized, for example, by a compact and space-saving design.

The contact sleeve 3 is received or arranged at least in sections in the support sleeve 2, which is described in more detail below.

The insulation 5 is preferably a sheath insulation made of a flexible insulating material. The flexible insulating material can be a plastic, for example. The contact sleeve 3 can be made on the basis of a copper alloy, preferably on the basis of pure copper. Alternatively, it is possible for the contact sleeve to be made of a brass alloy, preferably based on CuZn30 to CuZn42. The support sleeve 2 can preferably be designed as a sheet metal sleeve. The support sleeve 2 can for example be made of steel, stainless steel, or aluminum. The electrical conductor 4 can comprise a plurality of individual wires which are made on the basis of copper or a copper alloy. In other words, the support sleeve 2 is made of a support sleeve material, the contact sleeve 3 is made of a contact sleeve material, and the electrical conductor 4 with the individual wires is made of a conductor material. Preferably, the modulus of elasticity of the support sleeve material is greater than the modulus of elasticity of the conductor material. Furthermore, the yield strength of the support sleeve material is preferably less than the yield strength of the conductor material. Compared to the contact sleeve material of the contact sleeve 3, the support sleeve material of the support sleeve 2 preferably has a greater modulus of elasticity and/or a lower yield strength.

FIG. 2 shows a sectional view (section A-A in FIG. 1) of the embodiment of the connecting arrangement 1 shown in FIG. 1 before a crimp connection is formed.

The electrical conductor 4 with the plurality of individual wires 4E is shown schematically in FIG. 2. The stripped region, and thus the insulation-free section of the electrical conductor 4, is received in the longitudinal direction X in the support sleeve 2 and in particular in the contact sleeve 3. The insulation 5 makes contact with a stop element 2AS of the support sleeve 2 in the longitudinal direction X. The stop element 2AS is arranged on the inner surface of the support sleeve 2 in the hollow cylindrical section of the support sleeve 2, and is preferably annular.

On the opposite side of the insulation 5, the contact sleeve 3 is located on the stop element 2AS, which sleeve also makes contact with the stop element 2AS in the longitudinal direction X.

The contact sleeve 3 comprises an active section 3A inside the support sleeve 2. The active section 3A preferably comprises a region of the inner surface of the contact sleeve 3, which region is provided for forming a crimp connection at least in sections with the electrical conductor 4 received in the contact sleeve 3. The formation of the crimp connection by plastic deformation of at least one section of the contact sleeve 3, preferably of the active section 3A, and of individual wires 4E of the electrical conductor 4, can be produced using a crimping tool. The crimping tool can for example be a crimping pliers.

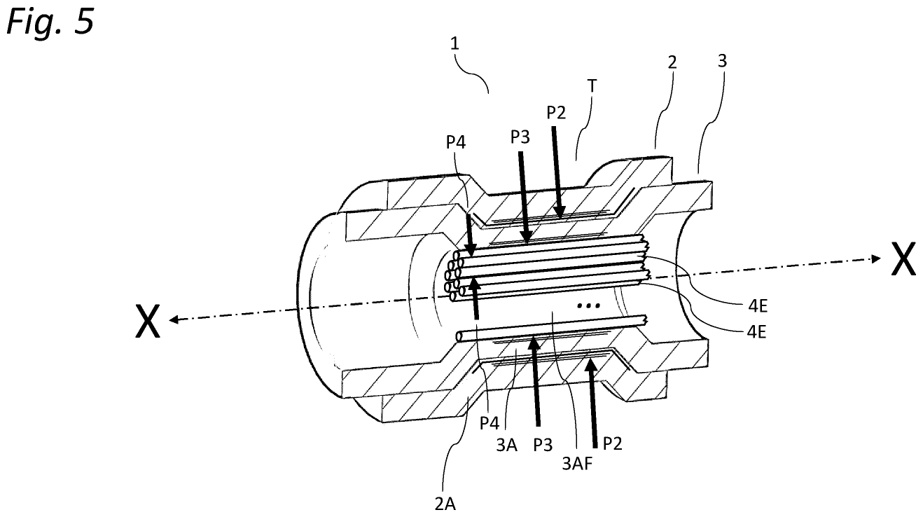

When forming the crimp connection, the support sleeve 2 is configured to at least maintain a contact surface pressure P3, P4 (see FIG. 5), preferably a radial contact surface pressure P3, P4 or a contact surface pressure P3, P4 substantially perpendicular to the longitudinal direction X, at least in sections between the active section 3A and the received electrical conductor 4, and/or at least in sections between the individual wires 4E of the electrical conductor 4. For this purpose, the support sleeve 2 has a support section 2A, wherein the support section 2A is assigned to the active section 3A. In other words, the support section 2A extends in the longitudinal direction X at least over and/or along the active section 3A.

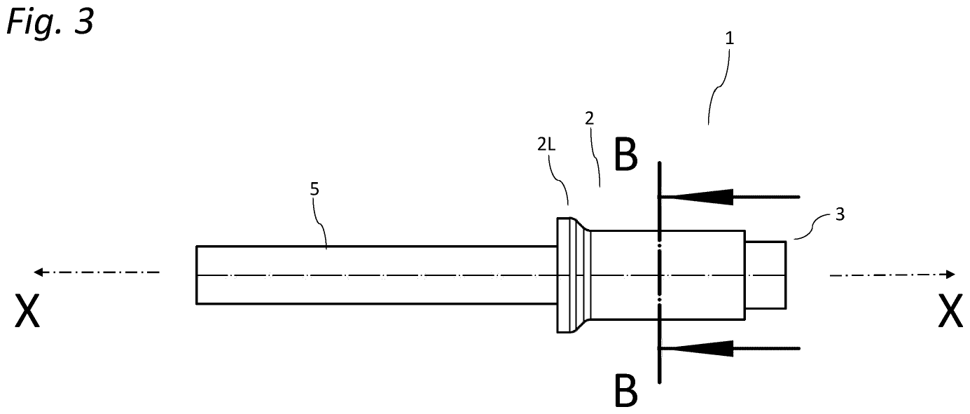

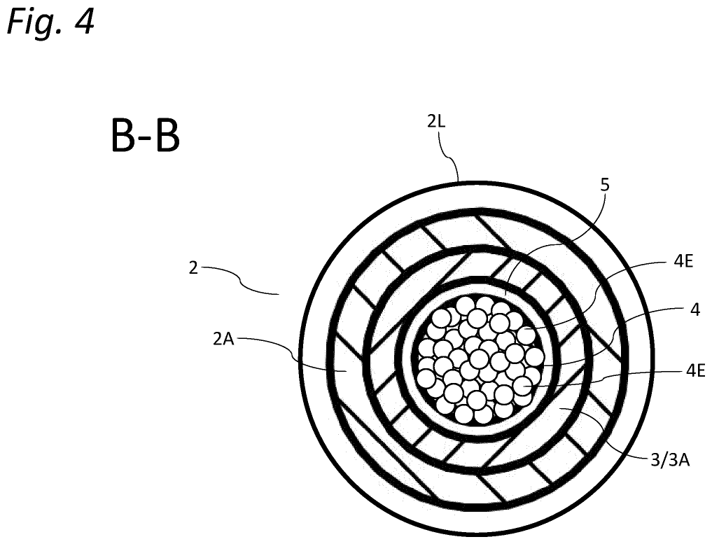

FIG. 3 shows a further side view of the embodiment of the connecting arrangement 1 according to the present invention before a crimp connection is formed. The further side view in FIG. 3 corresponds to the side view in FIG. 1 and serves to illustrate the sectional view shown in FIG. 4 of the section B-B shown in FIG. 3.

FIG. 4 shows a sectional view (section B-B in FIG. 3) of the embodiment of the connecting arrangement 1 shown in FIG. 3 before forming a crimp connection. In addition to the substantially circular cross-section of the support sleeve 2 and of the contact sleeve 3, especially the electrical conductor 4 with the plurality of individual wires 4E is clearly visible. Of the individual wires 4E of the electrical conductor 4, in FIG. 4 only two individual wires 4E are marked with the reference sign (“4E”), for reasons of clarity.

The gap that still exists between the electrical conductor 4 and the contact sleeve 3 before the crimp connection is formed is clearly visible, while the insulation 5 can be seen in the region of the gap in FIG. 4 due to the sectional view.

FIG. 5 shows a sectional view of a part of the embodiment of the connecting arrangement 1 when a crimp connection is formed. The crimp connection was produced here by means of a crimping tool, for example crimping pliers. For reasons of clarity, the crimping tool is not shown in the figures.

Both the contact sleeve 3 and the support sleeve 2 are plastically deformed in sections, and are thus permanently deformed. In the region of the active section 3A, the contact sleeve 3 and the support sleeve 2, and here in particular the support section 2A, form a waist T or narrow point of the connection arrangement 1. The waist T and thus the outer surface of the support section 2A have a substantially cylindrical shape in sections.

By plastic deformation of the support section 2A of the support sleeve 2 and the active section 3A of the contact sleeve 3 by a crimping tool, a crimp connection is formed together with the inserted or received electrical conductor 4 and, here, the individual wires 4E of the electrical conductor 4.

The individual wires 4E are also plastically deformed at least in sections and/or in part, preferably in the region of the active section 3A of the contact sleeve 3. Due to the plastic deformation of the contact sleeve 3 and of the support sleeve 2 in the corresponding sections, after the crimping tool has been used, a contact surface pressure P3 acting in particular on the individual wires 4E is exerted by the contact sleeve 3. The contact surface pressure P3 here acts via the inner surface 3AF of the contact sleeve 3 in the region of the active section 3A substantially perpendicular to the longitudinal direction X, and thus in the radial direction, on the corresponding outer surfaces of the individual wires 4E arranged corresponding to the inner surface 3AF.

The support sleeve 2, which preferably has a higher modulus of elasticity and a lower yield strength than the contact sleeve 3, now ensures, by exerting a contact surface pressure P2 on the support sleeve 3 and in particular on the active section 3A of the support sleeve 3, that the contact surface pressure P3 at least remains maintained, at least in sections, between the active section 3A, i.e. the inner surface 3AF in the region of the active section 3A, and the individual wires 4E of the electrical conductor 4 received therein. Furthermore, in the connection arrangement 1 according to the present invention, at least in sections, the contact surface pressure P4 between the individual wires 4E of the received electrical conductor 4 itself also remains maintained, at least substantially.

The support sleeve 2 thus serves to maintain the radial contact surface pressures P3 and P4 between the active section 3A and the individual wires 4E and/or between the individual wires 4E of the electrical conductor 4 itself.

After the crimping tool is opened, an elastic springing back can occur due to the material properties of the active section 3A and thus of the contact sleeve 3 and the individual wires 4E of the electrical conductor 4, which would lead to a reduction in the contact surface pressures P3, P4. This reduction of the contact surface pressures P3, P4 is now substantially prevented by the support sleeve 2, and preferably by the support section 2A of the support sleeve 2. The support sleeve 2 induces, so to speak, a substantially permanent and/or constant and preferably increased contact surface pressure P2 into the contact sleeve 3, and in turn ensures that the contact surface pressures P3 and P4 of the contact sleeve 3 with the individual wires 4E are substantially at least maintained. This is preferably ensured or achieved by the material properties both of the support sleeve 2 and the contact sleeve 3 and the individual wires 4E of the electrical conductor 4. Preferably, the support sleeve 2 has a sufficient degree of deformation.

The connecting arrangement 1 according to the present invention is accordingly characterized in that, when the crimp connection is formed, corresponding contact surface pressures P3, P4 within or in the region of the crimp connection are at least substantially maintained due to the provision of a support sleeve 2. The connecting arrangement 1 according to the present invention is thus characterized by a corresponding electrical contact quality.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 crimp connection
2 support sleeve
2A support section
2L conductor insertion section
3 contact sleeve
3A active section
3AF inner surface
4 electrical conductor
4e individual wire
5 insulation
P3 contact surface pressure
P4 contact surface pressure
T waist (narrow point)
X longitudinal direction

1. A connecting arrangement, comprising:
a support sleeve; and
a contact sleeve configured to receive an electrical conductor which has individual wires as a received electrical conductor,
wherein the contact sleeve is received at least in sections in the support sleeve,
wherein the contact sleeve comprises an active section configured to form a crimp connection at least in sections with the received electrical conductor, and
wherein the support sleeve is configured at least to maintain a contact surface pressure, at least in sections, between the active section and the received electrical conductor and/or, at least in sections, between the individual wires of the received electrical conductor.

2. The connecting arrangement of claim 1,
wherein the active section and/or a support section of the support sleeve assigned to the active section is plastically deformable or plastically deformed at least in sections.

3. The connecting arrangement of claim 1,
wherein the support sleeve comprises a support sleeve material, and the contact sleeve comprises a contact sleeve material, and
wherein a modulus of elasticity of the support sleeve material is greater at least in a region of an ideally elastic-plastic material behavior than a modulus of elasticity of the contact sleeve material.

4. The connecting arrangement of claim 1,
wherein the support sleeve comprises a support sleeve material, and the contact sleeve comprises a contact sleeve material, and
wherein a yield strength of the support sleeve material is smaller, at least within a range of an ideally-elastic plastic material behavior, than a yield strength of the contact sleeve material.

5. The connecting arrangement of claim 1,
wherein the electrical conductor comprises a conductor material, and the support sleeve comprises a support sleeve material, and
wherein a yield strength of the support sleeve material is smaller than a yield strength of the conductor material.

6. The connecting arrangement of claim 1,
wherein the support sleeve has a conductor insertion section, and
wherein the conductor insertion section is funnel-shaped at least in sections.

7. The connecting arrangement of claim 1,
wherein the contact sleeve is rotationally symmetrical, at least in sections, at least in a region of the active section.

8. The connecting arrangement of claim 1,
wherein the support sleeve has, at least in sections, at least one support section in a region of the active section, and
wherein at least the support section is rotationally symmetrical.

9. The connecting arrangement of claim 1,
wherein the support sleeve has at least one stop element configured to support the contact sleeve and/or an insulation of the electrical conductor in a longitudinal direction.

10. The connecting arrangement of claim 1,
wherein the support sleeve has at least one recess extending at least in sections around a circumference of the support sleeve.

11. The connecting arrangement of claim 1,
wherein the support sleeve extends in a longitudinal direction at least over the active section.

12. The connecting arrangement of claim 1,
wherein the support sleeve and the contact sleeve form, at least in sections, a positive and/or non-positive connection.

13. The connecting arrangement of claim 1,
wherein the contact sleeve comprises a copper alloy or of a brass alloy, and/or
wherein the electrical conductor comprises copper.

14. A method for producing the connecting arrangement, claim 1, the method comprising:
receiving the contact sleeve at least in sections in the support sleeve as a received contact sleeve,
the received contact sleeve in the support sleeve comprising the active section;
receiving the electrical conductor in the received contact sleeve; and
forming a crimp connection, at least in sections, by a crimping tool which is applied to the support sleeve in a region of the active section.

15. The connecting arrangement of claim 1, wherein the contact sleeve is received at least in sections in the support sleeve in a longitudinal direction.

16. The connecting arrangement of claim 3, wherein the contact sleeve material is electrically conductive.

17. The connecting arrangement of claim 5, wherein the individual wires of the electrical conductor comprise the conductor material.

18. The connecting arrangement of claim 6, wherein the conductor insertion section, in a longitudinal direction thereof, merges into the support section.

19. The connecting arrangement of claim 7, wherein the contact sleeve is hollow-cylindrical.

20. The connecting arrangement of claim 8, wherein at least the support section is hollow-cylindrical.
